(19) United States
(12) Patent Application Publication
(10) Pub. No.: US 2003/0121028 A1
(43) Pub. Date: Jun. 26, 2003

(54) Quantum computing integrated development environment

(76) Inventors: Michael Coury, Vancouver (CA); Geordie Rose, Vancouver (CA); Jeremy P. Hilton, Vancouver (CA)

Correspondence Address: Pennie & Edmonds LLP, 3300 Hillview Avenue, Palo Alto, CA, 94304-1203, US

(21) Appl. No.: 10/028,891

(22) Filed: Dec. 22, 2001

(51) Int. Cl. G06F 9/45

(52) U.S. Cl. 717/138

(57) ABSTRACT

A quantum integrated development environment is provided for designing quantum logic that utilizes N qubits, compiling the quantum logic into quantum machine language instructions, and running the machine language instructions on a quantum computing system. Additionally, the results of the execution are provided as an output.

### CROSS-REFERENCE TO CD-ROM APPENDIX

An Appendix containing a computer program listing is submitted on a compact disk, which is herein incorporated by reference in its entirety. The total number of compact discs including duplicates is two. Appendix A, which is part of the present specification, contains a list of the files contained on the compact disk. These listings contain material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### BACKGROUND OF THE INVENTION

1. Field of the Invention

The invention relates to quantum computers and to digital computer systems simulating the operation of a quantum computer.

2. Description of Related Art

Research on what is now called quantum computing traces back to Richard Feynman. See, e.g., R. P. Feynman, Int. J. Theor. Phys. 21, 467 (1982). Feynman noted that quantum systems are inherently difficult to simulate with classical (e.g., conventional, non-quantum, digital) computers, but that this task could be accomplished by observing the evolution of another quantum system. In particular, solving a theory for the behavior of a equation related to the system's Hamiltonian. Observing the behavior of the system provides information regarding the solutions to the equation.

Further efforts in quantum computing were initially concentrated on building the formal theory or on “software development” or extension to other computational problems. Discovery of the Shor and Grover algorithms were important milestones in quantum computing. See, e.g., P. Shor, SIAM J. of Comput. 26, 1484 (1997); L. Grover, Proc. 28th STOC, 212 (ACM Press, New York, 1996); and A. Kitaev, LANL preprint quant-ph/9511026. In particular, the Shor algorithm permits a quantum computer to factorize large natural numbers efficiently. In this application, a quantum computer could potentially render obsolete all existing “public-key” encryption schemes. In another application, quantum computers (or even a smaller-scale device such as a quantum repeater) could enable absolutely safe communication channels where a message, in principle, cannot be intercepted without being destroyed in the process. See, e.g., H. J. Briegel et al., preprint quant-ph/9803056 and references therein. Showing that fault-tolerant quantum computation is theoretically possible opened the way for attempts at practical realizations. See, e.g., E. Knill, R. Laflamme, and W. Zurek, Science 279, 342 (1998).

Several physical systems have been proposed for the qubits in a quantum computer. Qubits are the fundamental building blocks of a quantum computer. A qubit is a system having two degenerate (i.e., of equal energy) quantum states, with a non-zero probability of being found in either state. Thus, N qubits can define an initial state that is a combination of 2^{N} classical states. One system uses molecules having degenerate nuclear-spin states. See N. Gershenfeld and I. Chuang, “Method and Apparatus for Quantum Information Processing,” U.S. Pat. No. 5,917,322. Nuclear magnetic resonance (NMR) techniques can read the spin states. These systems have successfully implemented a search algorithm, see, e.g., M. Mosca, R. H. Hansen, and J. A. Jones, “Implementation of a quantum search algorithm on a quantum computer,” Nature 393, 344 (1998) and references therein, and a number-ordering algorithm, see, e.g., L. M. K. Vandersypen, M. Steffen, G. Breyta, C. S. Yannoni, R. Cleve, and I. L. Chuang, “Experimental realization of order-finding with a quantum computer,” preprint quant-ph/0007017 and references therein. (The number-ordering algorithm is related to the quantum Fourier transform, an essential element of both Shor's factoring algorithm and Grover's algorithm for searching unsorted databases.)

The fundamental building block of a quantum computer is the quantum bit or qubit. The qubit can have two basis states, |0> and |1>, just like a bit in classical computing. During computation, however, there is no classical computing analogy, as the state of the qubit becomes a quantum superposition of it basis states, and evolves according to the rules of quantum mechanics.

Flux Qubits

One proposal for a qubit is a superconducting flux qubit, proposed by Mooij et al Science 285, p. 1036 (1999). This qubit consists of an internal superconducting loop that includes three or more Josephson junction, inductively coupled to an external dc-SQUID that includes two Josephson junctions. The dc-SQUID has leads through which a bias current can be driven. The bias current through the leads provides a basis for operating on the inner loop, which forms the qubit.

The Mooij qubit can be biased to adjust the energy-phase profile. This DC bias or flux bias adjusts the relative values of the double well of the energy phase profile. Coupling of these qubits can be accomplished via inductive coupling that leads to sigma x and sigma z interactions between respective qubits in the Hamiltonian of the quantum system.

For the structure disclosed by Mooij et al the coupling of qubits and hence much of the behavior of the overall quantum computer can be accomplished in a simple manner. All quotes from Makhlin et al, Rev. Mod. Phys. 73 357 (March 2001) “In order to couple different flux qubits one can use a direct inductive coupling (Mooij et al., 1999; Orlando et al., 1999).” This involves loop establishing a mutual inductance between qubits. This “mutual inductance between the qubits can be established in different ways.” The simplest is to place a switchable LC circuit over the qubits to be coupled. Flux from the circuit can thread the qubits. “Since fluxes through these loops control the barrier heights of the double-well potentials, this gives rise to the interaction term σ_{X}¹σ_{X}². Placing the loop differently produces in addition contributions to the interaction Hamiltonian of the form σ_{Z}² σ_{Z}²″ The quote continues “The typical interaction energy is of order MI²_{c} where M is the mutual inductance and Ic is the critical current in the junctions. For their design, Mooij et al. (1999) estimate the typical interaction energy to be of order 0.01E_{J}; 50 mK in frequency units, i.e., of the order of single-qubit energies.”

As to the coupling with control Makhlin continues “In the simplest form this interaction is always turned on. To turn it off completely, one needs a switch controlled by high-frequency pulses. The related coupling to the external circuit leads to decoherence (see the discussion at the end of this section). An alternative is to keep the interaction turned on constantly and use ac driving pulses to induce coherent transitions between the levels of the two-qubit system (see Shnirman et al., 1997; Mooij et al., 1999). A disadvantage of this approach is that permanent couplings result in an unwanted accumulation of relative phases between the two-qubit states even in the idle periods. Keeping track of these phases, or their suppression by repeated refocusing pulses, requires a high precision and complicates the operation.”

Charge Qubits

An example of a charge qubit was proposed in A. Shnirman and G. Schön, Phys. Rev. B 57 15400 (1998) is the superconducting electron box. It consists of a superconducting island connected by a Josephson junction to a superconducting electrode with capacitive coupling C to a gate electrode. A control voltage Vₓ is applied via the gate capacitor. The Josephson junction is characterized by the Josephson energy E_{J} (which is related to the Josephson critical current Ic by E_{J}=I_{C}Φo/2π, and Φo≡h/2e is the flux quantum) and by the capacitance C_{J} which determines the charging energy scale. In this system charge in the box and phase across the junction are canonically conjugated variables. The system will decohere if it is not superconducting, i.e. currents are kept below Ic. The bit sates are again pseudo spin variables that correspond to charge states |⇓>=|n> and |↑>=|n+1>, where n is an integer number of Cooper pairs.

The qubit evolution in Hilbert space is governed by a Hamiltonian proportional to the σ_{Z} and σ_{X} Pauli matrices. The coefficient on the σZ term controlled by the gate voltage across C. This is in absence of interaction between qubits. Again these qubits can be inductively coupled and with a circuitry configuration found in Yu. Makhlin et al FIG. 4 page 362. This yields a Hamiltonian for a system that is based on the σ_{X} self evolution and a σ_{y}¹ σ_{y}² term for the qubit-qubit coupling terms. The complete Hamiltonian is on page 363, Ibid.

Electrons on Helium

The electrons of this qubit proposal behave like artificial single electron atoms governed by the Bohr model. The wave functions of the first and second excited state are the bit states of the qubit. Note they are not degenerate. A vertical potential well V(z) α−1/z confines the electrons. The system has analogous behavior to atomic models with its own Rydberg constants and Bohr radius, a_{B} that depends on the isotope of Helium used. The system is therefore analogous to one of the most studied models in mathematical physics. There is an energy transition from the first state with expectation value <Zₒ>=1.5 a_{B} to the expected vertical position of the second state <Z₁>=6 a_{B}. The energy difference is fᵣ=(E₁−E₀)/h in frequency units. Therefore, pulses like those used in NMR studies can be used to elevate the state of these individual artificial atoms. The electrons would be arranged in an artificial crystal structure called a Winger crystal. Each atom would be addressable, allowing the tuned pulse to interact with the atoms. The qubit-qubit interactions are governed by a Hamiltonian that has terms proportional to all the Pauli matrices and their complex linear combinations. The qubit-qubit interaction is always on and is only modulated by range. See M. J. Lea et al and M. I. Dykman et al in S. L Braunstein and H.-K. Lo (Eds.) Scalable Quantum Computers, Wiley-VCH Berlin (2001).

For further discussion of qubit operations and control systems for performing quantum computation, see patent application Ser. No. 09/872,495, titled “Quantum processing system and method for a superconducting phase qubit”, filed on Jun. 1, 2001, and the references cited therein, which are incorporated herein by reference in their entirety.

Proposals for quantum computing programming languages and architectures have been made. See, e.g., S. Bettelli, T. Calarco, and L. Serafini, “Toward an architecture for quantum programming”, LANL cs.PL/0103009 v.2 (November 2001), and the references therein. This paper addresses the computer science problem of how quantum computers could be used. As stated on page 1 in the abstract:

“[t]his paper investigates a possible approach to the problem of programming such machines: a template high level quantum language is presented which complements a generic general purpose classical language with a set of quantum primitives. The underlying scheme involves a run-time environment which calculates the byte-code for the quantum operations and pipes it to a quantum device controller or to a simulator.”

This paper however, fails to address the complexities related to different physical embodiments of quantum computers, and thus does not teach reduction to such byte-code for controlling a quantum computer. Furthermore, the paper states on page 3, “the language must allow an automated scalable procedure for translating and optionally optimizing the high level code down to a sequence of low level control instructions for quantum machines.”

Such a scalable procedure is not taught in the paper and furthermore, as quoted from above, such a reduction is not described with respect to potential physical systems. Such a procedure is not enabled, nor is it portrayed accurately. Thus the paper teaches a high level programming language that cannot drive a quantum computing system.

There is a need for a development tool with a substantial basis in the physical parameters required to drive a quantum computing system, and as such provide a useful environment in which such a tool can be used.

### SUMMARY OF THE INVENTION

In accordance with the present invention, a quantum computing integrated development environment (QC-IDE) and method are provided for designing quantum logic with N qubits, compiling the quantum logic into a set of quantum machine language instructions, executing the quantum machine language instructions, and outputting the results generated by the execution of the quantum machine language instructions.

Designing quantum logic includes selecting a quantum computing system, and designing a sequence of fundamental operators, wherein said set of fundamental operators depends on the choice of quantum computing system. Furthermore, a mechanism for designing quantum logic can include defining a sequence of fundamental operators as an abstract operator, and designing a sequence of abstract operators. In some embodiments of the invention, a mechanism for designing quantum logic includes performing a readout operation, and defining conditional operations, that can be executed based on the desired conditions. A readout operation can include performing a readout operation of one or more qubits in a quantum register, wherein a readout operation collapses the quantum state of the qubit to a binary equivalent, and a conditional behavior can include application of fundamental operators or abstract operators on one or more qubits in said quantum register. The conditional operations can be applied to one or more of said collapsed qubits, or non-collapsed qubits.

Designing quantum logic can further include setting driver details for a quantum register. The driver details for the register depend on the choice of quantum computing system. The driver details may include parameters such as the minimum duration for application of fundamental operators or the sharpness of the pulses that can be applied. Designing quantum logic can further include preparing the initial conditions of each of the qubits in the quantum computing system.

Compiling quantum logic to a set of quantum machine language instructions includes collapsing a set of abstract operators into a set of fundamental operators. A mechanism for compiling quantum machine language instructions can further include collapsing a sequence of fundamental operators, in accordance with a set of rules for optimizing fundamental operators.

The quantum machine language instructions are executed by a quantum register and a control system for interacting with the quantum register. A quantum register includes an array of qubits. The basic operations performed on a quantum register are an initialization operation, evolving the state of the quantum register by application of a set of fundamental operators, and a readout operation. The control system can interact with the quantum register to coordinate and time each of the respective operations, as specified by the quantum machine language instructions. In some embodiments of the invention, the quantum machine language instructions are executed by a simulator of a quantum computing system.

Once execution of said machine language instruction set is complete, the quantum register exists in a quantum superposition of its basis states. Such a superposition can then be collapsed to a single basis state to provide a result to the calculation. The final state of the quantum computing system after execution of the quantum machine language instructions provides the result of the calculation.

Some embodiments of the invention allow a user to choose a desired hardware platform, and then provide tools that will aid in designing machines at the hardware, machine language, logic, and software levels. An embodiment of the invention allows the user to control each of these aspects, providing an “integrated development environment” (IDE) in which all phases of computational engine design may be accomplished.

### BRIEF DESCRIPTION OF THE DRAWINGS

FIG. 1 is a flow diagram illustrating interactions amongst components of a QC-IDE, in accordance with some embodiments of the invention.

FIG. 2A is an entity-relationship diagram describing a quantum logic design process, in accordance with some embodiments of the invention.

FIG. 2B is a block diagram illustrating components of an execution portion of a QC-IDE, in accordance with some embodiments of the invention.

FIG. 2C is a block diagram illustrating components of an output portion of a QC-IDE, in accordance with some embodiments of the invention.

FIG. 3 illustrates a collection of fundamental operations associated with a two-qubit quantum system, in accordance with some embodiments of the invention.

FIG. 4 is a block diagram of a QC-IDE used as a calibration tool for a quantum computing environment, in accordance with some embodiments of the invention.

### DETAILED DESCRIPTION OF THE INVENTION

Quantum computing generally involves initializing the states of N quantum bits (qubits), creating controlled entanglements among them, allowing these states to evolve, and reading out the qubits after the states have evolved. A qubit is conventionally a system having two degenerate (i.e., of equal energy) quantum states, with a non-zero probability of being found in either state. Thus, N qubits can define an initial state that is a combination of 2^{N} classical states. This initial state undergoes an evolution, governed by the interactions that the qubits have among themselves and with external influences. This evolution of the states of N qubits defines a calculation or in effect, 2^{N} simultaneous classical calculations. Reading out the states of the qubits after evolution is complete determines the results of the calculations.

Proposals for quantum computing systems must provide a basic set of quantum operations, or fundamental operators, which are specific to that system. In order to be suitable for quantum computation, a quantum system must be designed to provide \hat{σ}_{X} operations, herein after referred to as X, \hat{σ}_{Z} operations, herein after referred to as Z, \hat{σ}_{Y} operations, herein after referred to as Y, and an entanglement operation, or a subset of these operations. For example, one well known quantum computing system is NMR, in which all of the operations can be achieved. Other systems described in detail and referenced in the prior art section of this application include the Mooij et al flux qubit, the Yu. Makhlin et al charge qubit, and the electrons on Helium proposal. Each of these proposals are related to superconducting systems, but proposals for physical quantum computing systems can include more general physical systems exhibiting quantum mechanical behavior. Any sequence of quantum logic can be broken down in terms of these fundamental operations (also referred to as “gates”). Thus, these gates make up an important part of the quantum machine language of the quantum computer, along with instructions for initialization and readout operations.

The computational space available for a quantum computation grows with the number of qubits associated with that system as 2^{N}, where N is the number of qubits in the system. Building and designing algorithms for quantum systems is a highly complex task as it involves working with matrices of sizes 2^{N}×2^{N}, which grow beyond feasibility even for a small number of qubits. Consequently, such simulations can only be useful as a tool for teaching fundamentals of quantum computing, and for the design of physical quantum computing systems. Furthermore, current quantum simulators have little basis in any physical quantum computing proposals. See, e.g., Qucalc.m, which is herein incorporated by reference in its entirety. Qucalc.m is a commonly used Mathematica package that simulates quantum computing operations. It is based on qualitative quantum computing and has little emphasis or concern for physical quantum computing systems. By contrast, some embodiments of the invention provide a QC-IDE in which physically realistic and scalable quantum computing can be designed and tested.

A quantum computing, integrated development environment (QC-IDE,)in accordance with some embodiments of the present invention, supports designing quantum logic, compiling the quantum logic into quantum machine language instructions, executing the quantum machine language instructions, and providing as output the results of the execution. The QC-IDE can be used to develop quantum algorithms, to optimize quantum algorithms, and to perform quantum computation. The tools currently available for accomplishing these tasks are entirely based on mathematical principles, modeling quantum mechanical evolution without consideration of constraints imposed by realistic implementations of quantum computing systems. As a result, the QC-IDE provides a tool for enabling development in a quantum computing environment.

Some embodiments of the invention are used to model quantum systems such as many-body electron systems, nuclear fusion or nuclear fission, or protein folding systems and the like. Current methods for simulating such systems are inadequate in terms of required computer resources and time.

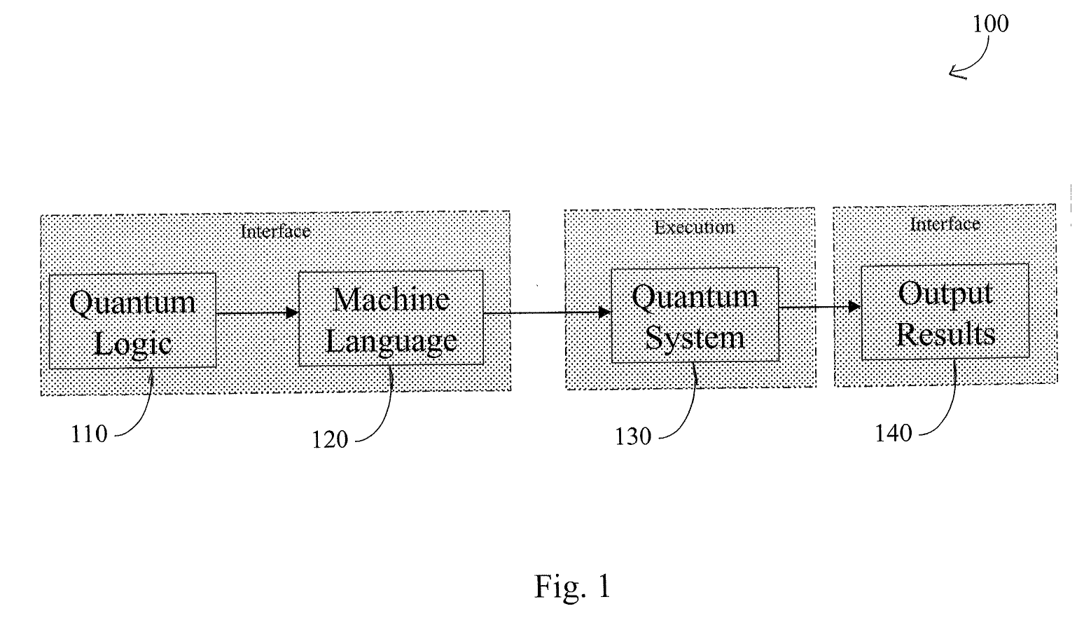

FIG. 1 is a flow diagram of an embodiment of the invention. The flow diagram illustrates the sequence of operations supported by the QC-IDE. Quantum logic design is performed in design stage 110. Compilation stage 120 follows design stage 110. In compilation stage 120 the quantum logic designed in design stage 110 is compiled into a sequence of quantum machine language instructions. It should be noted that these quantum machine language instructions may include classical machine language instructions that can be executed by a classical (e.g. digital) computer, but must include at least one quantum machine language instruction that can only be executed by a quantum computing system. Execution stage 130 follows compilation stage 120. In execution stage 130 the quantum machine language instructions are executed in a quantum computing system. Finally, in output stage 140, the results of the calculation are provided as an output.

In accordance with some embodiments of the invention, a mechanism for designing quantum logic includes designing a sequence of fundamental operations. Quantum computing logic can be defined as a sequence of unitary transformations acting on a quantum state. The fundamental operations of quantum computing logic include the set of quantum unitary transformations that a quantum computer can implement. Generally, the fundamental operations can consist of X, Y, Z, and an entanglement operation. In some embodiments, a ground or readout operation can also be included.

In some embodiments, methods for designing quantum logic may include creating a time-resolved sequence of fundamental operations, such that the combination, when applied to the initial state of the quantum system, evolves the initial state of the quantum system to some final state. In some embodiments, methods for designing quantum logic include designing a time-resolved set of operators, compiling said sequence into a set of machine language instructions, executing said instruction set on the quantum computing system, obtaining the results of the execution, adjusting the sequence of fundamental operators as required, and iterating this process until the desired quantum logic has been implemented.

In accordance with some embodiments of the present invention, designing quantum logic may include controlling the characteristics of a driver hardware. A quantum computing system includes a quantum register, and the quantum register, in turn, contains a plurality of qubits. A control system for implementing the fundamental operations on each of the qubits in the quantum register, and a control processor for coordinating the operations required. A mechanism for controlling the characteristics of the driver hardware or control processor includes setting a time unit resolution or minimum duration of the operation. Further, the sharpness of the pulses can be calibrated in accordance to the characteristics of the driver hardware. Optimal driver settings ultimately depend on the physical characteristics of the quantum computing system. For example, patent Ser. No. 09/872,495 incorporated by reference above describes current pulses with frequency on the order of GHz, and magnitudes on the order of nanoAmperes. Such driver settings can be useful for phase or flux qubits, but other physical systems can demands different driver capabilities. In some embodiments of the invention, the target quantum computing system can be selected before the quantum logic is designed. When a target platform is selected, the driver details vary according to the requirements of that system. However, at any point, the driver characteristics can be modified to aid in the design of an algorithm.

In some embodiments of the invention, designing quantum logic includes defining the number of qubits required and the possible connections between them, using a fundamental operator, quantum logic design tool. Designing a sequence of fundamental operators, in turn, includes selecting the desired operator sequence and setting the appropriate driver conditions, setting the initial state of each of the qubits in the quantum register, compiling the sequence of operations into quantum machine language instructions, executing the quantum machine language instructions on the quantum computing system, and assessing the result of the executing sequence of operations. If the output from the calculation does not satisfy the desired output, the process can be repeated by iteratively re-designing the pulse sequence using the fundamental operator design tool until the desired results are obtained. This process represents the most fundamental level of quantum logic design.

Designing quantum logic includes the use and/or creation of abstract quantum gates. Each abstract quantum gate includes a sequence of fundamental operations and driver characteristics. An abstract quantum gate can be used to design high level quantum logic. As a sequence of the fundamental operations, each abstract quantum gate can be combined with other abstract quantum gates to form a sequence of abstract quantum gates, thus enabling the use of high level quantum logic. Some embodiments of the invention include creating abstract quantum gates, and designing high level quantum logic that includes a sequence of abstract quantum gates. An abstract quantum gate can act upon a single qubit or a plurality of qubits. In some embodiments, an abstract quantum gate includes a sequence of abstract quantum gates. This is particularly advantageous for designing complex quantum logic that involves many qubits.

In some embodiments of the invention, an abstract quantum gate can be designed by building the desired sequence of fundamental operators and exporting the sequence as an abstract quantum gate. Building a sequence of fundamental operators can be accomplished using the fundamental operator, quantum logic design tool as described above. Once a sequence of fundamental operators has been designed, the sequence can be defined as a single abstract gate. In some embodiments of the invention, an abstract quantum gate can then be used with a high-level quantum logic design tool.

In some embodiments of the invention, quantum logic includes a set of abstract operators, wherein a set of abstract operators depends on the target quantum computing system. Some embodiments of the invention can include a set of defined quantum computing systems. Further, some embodiments of the invention include defining quantum computing systems. As a result, a quantum computing system can simulate another quantum computing system accurately.

In accordance with the present invention, designing quantum logic includes designing a set of conditional actions based on the results of a qubit readout operation. In some embodiments of the invention, conditional behavior can be based on the readout of a plurality of qubits. Quantum algorithms often require readout of a qubit state and some conditional actions that are based on that readout. See, e.g., U.S. Pat. No. 5,768,297, P. Shor, “Method for Reducing Decoherence in Quantum Memory”, filed October, 1996, and the references therein. Error decoding operations typically involve reading out the state of certain ancillary qubits, and performing operations on other qubits based on those measurements in order to remove possible error from the information. Further, readout and subsequent conditional behavior is typically used for quantum teleportation. In the '297 patent decoding a logical quantum state involves measuring two qubits and then performing a NOT quantum operation on a certain target qubit based on the outcome of the readout.

Some embodiments of the invention include designing conditional quantum logic, such that a set of quantum operations is executed providing the outcome of a readout operation (or set of readout operations). In some embodiments, a readout operation can be performed on a plurality of qubits, and conditional quantum logic based on the outcome of the readout operation can be designed. Conditional logic can apply to a qubit that remains in a quantum state, in other words, a qubit that did not have a readout operation applied. A set of quantum operations that can be executed based on the readout may include a set of fundamental operators and/or a set of abstract operators, available to the respective quantum computing system. Any fundamental operator, or defined set of fundamental operators, available to the QC-IDE can be used as a basis for the conditional behavior. For example, a quantum logic design can include three qubits. After some evolution of the set of qubits has occurred, the second and third qubit can be read out, and subsequently, a set of operators can be applied, conditional on the result of the readout operations. An example of a conditional statement is illustrated by the following pseudocode:

if ( (readout of qubit 2) and

(readout of qubit 3) are in bit state 1)

then apply a quantum operation to qubit[1]

else

continue without applying any conditional

quantum operations.

In some embodiments of the invention, a set of conditional behavior can be defined based on a set of readout operations on qubits in the quantum computing system.

In order to convert quantum logic, expressed in the form of a set of abstract operators, into a set of quantum machine language instructions, the abstract operations must first be compiled into an equivalent set of fundamental operators. Compiling quantum logic includes converting a set of abstract operations into a set of fundamental operations, and incorporating the driver settings into the fundamental operations to create a set of quantum machine language instructions.

Converting a set of abstract operators into a set of fundamental operations includes optimizing the sequence of fundamental operations. Since decoherence processes in quantum computing systems render the time required to execute a calculation of critical importance, optimization of the set of fundamental operations becomes important for execution of the quantum logic. U.S. patent Ser. No. 09/782,886, A. Blais, “Optimization Method for Quantum Computing Process”, filed February, 2001, and the references therein, which are incorporated herein by reference in their entirety, describe rules on which optimization of a set of fundamental operators can be reduced. In some embodiments of the invention, these rules include commutation of fundamental operators, removal of empty time units, and removal of redundant pulse sequences or replacement by simplified pulse sequences. Commutation of fundamental operators allows quantum gates that do not interfere with each other to overlap or change their order in time. For example, a X operation on qubit 1, does not interfere with a X operation on qubit 2, and the time-resolved sequence X(1)X(2)=X(2)X(1). Commutation operations depend on the quantum computing system, since the choice of quantum computing system can determine which fundamental operators commute. For example, the effect of a coupling operation between two qubits can depend on the nature of the coupling, and the coupling in turn depends on the quantum computing system.

Once a desired logic has been developed, it can be defined as an abstract quantum operator for that quantum computing system. A set of abstract quantum operators can be used to implement high level quantum logic such as a quantum Fourier transform (QFT) for example. See, e.g., U.S. patent Ser. No. 09/782,886, by A. Blais, referenced above. This high level of quantum algorithm development provides a level of abstraction useful for building such complex quantum algorithms. Further, due to the sensitivity of quantum computing systems to possible errors, individual qubit states can be encoded as logical qubits, wherein a plurality of physical qubits can be used to encode a single qubit state, such that the state is protected from errors during the computation. Such algorithms can include aspects similar to classical error correction algorithms, see, e.g., P. Shor, referenced above.

When high level quantum logic is used for design some lack of efficiency results when a set of abstract operators are directly converted to a set of quantum machine language instructions to be executed. For example, in the A. Blais patent application referenced above, a controlled not (ON) gate is defined as the following sequence of fundamental operations:

$${CN}_{rs} = {ⅇ}^{- i \frac{3 π}{4}} {X}_{s} {CP}_{rs} {Z}_{s} {X}_{s} {Z}_{s} {Z}_{r} {CP}_{rs} .$$

This pulse sequence consists of fundamental quantum gates that are available in most solid state quantum computing systems. The CPᵣₛ gate is an entanglement operation between two qubits having the effect of a ZᵣZₛ operation. A SWAP₁₂ quantum gate is defined as:

SWAP₁₂=CN₁₂CN₂₁CN₁₂,

thus, by defining the CNᵣₛ operation between two qubits as an abstract operator, the SWAPᵣₛ operator can be further defined as an abstract quantum operator using a sequence of the CNᵣₛ abstract quantum operators. Direct conversion of the sequence described above for the SWAP abstract operator to a sequence of fundamental operators results in some degree of redundancy. Using optimization rules such as commutation of operators, certain simplifications can be automated, in accordance to some embodiments of the invention. For example, the CNᵣₛ illustrated above can be re-sequenced as the following:

$${CN}_{rs} = {ⅇ}^{- i \frac{3 π}{4}} {X}_{s} [ {CP}_{rs} {Z}_{s} ] {X}_{s} [ {Z}_{s} {Z}_{r} {CP}_{rs} ] ,$$

where the square braces indicate that the operators within can be performed simultaneously, thus reducing the total required time to execute the instructions. Similar reductions result from the fundamental operators associated with the SWAP expansion.

In some embodiments of the invention, quantum logic can be designed using fundamental operators of the quantum computing system directly. In this case, the QC-IDE can be used to optimize the set of fundamental operations, and compiling includes combining driver details with the set of fundamental operators to be executed on the quantum computing system.

Once the quantum logic and driver details are compiled, a set of quantum machine language instructions exist that can be executed on the quantum computing aspect of the software. The nature of the machine language instructions depend upon the mechanism for executing those instructions. For example, a mechanism for executing the instruction set can be a particular quantum computing system, or a simulation of that system. Thus, the set of fundamental operators available varies for each quantum computing system.

A quantum machine language instruction set can be executed on any quantum computing system. A quantum computing system includes any quantum mechanical system where a set of basis states (as described with respect to a qubit in the prior art section) can be used to compute in accordance with quantum mechanical principles. A quantum system useful for quantum computing must provide at least some degree of control over the information units or qubits of the system. For example, each quantum computing system must be able to initialize the state of a qubit, perform a sequence of unitary evolutions of the system, and perform a readout operation on the state of the qubit. Quantum computing systems such as this can be called quantum registers, where the operations required for quantum computing can be applied to a plurality of qubits. Quantum register structures are described, for example, in U.S. patent Ser. No. 09/872,495, M. Amin, J. Hilton, G. Rose, A. Zagoskin, “Quantum Processing System and Method for a Superconducting Phase Qubit”, filed June, 2001, and the references therein, which are incorporated herein by reference in their entirety.

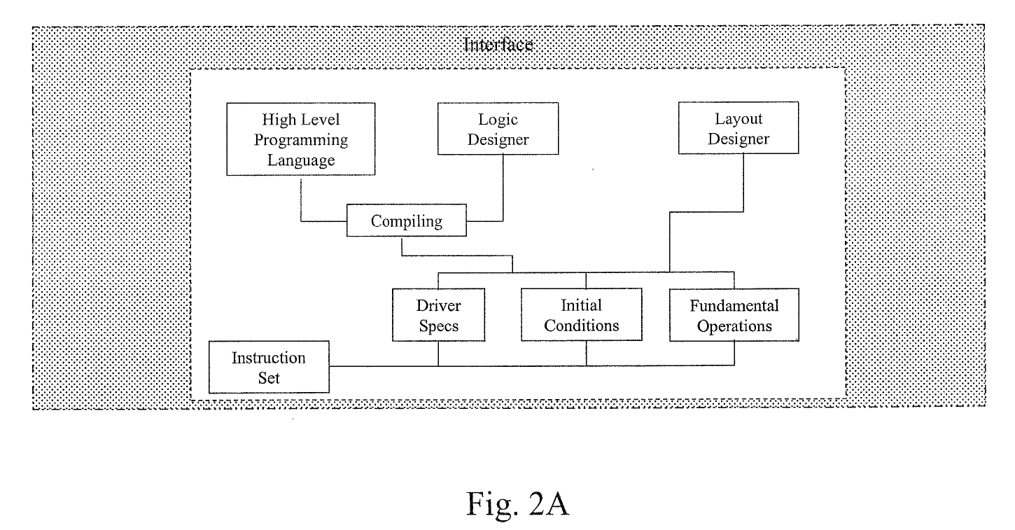

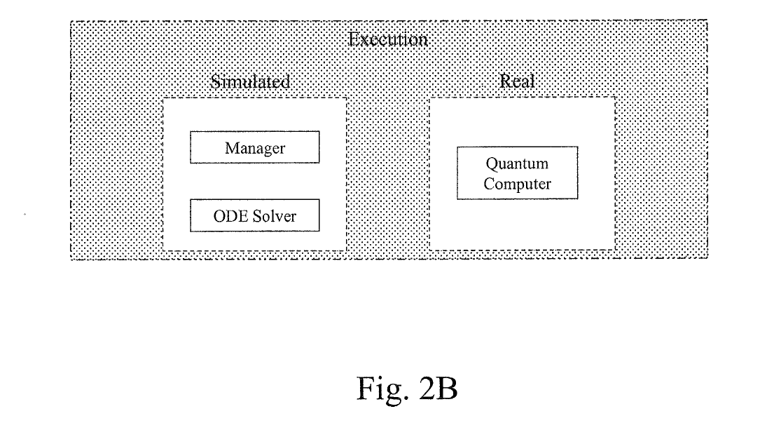

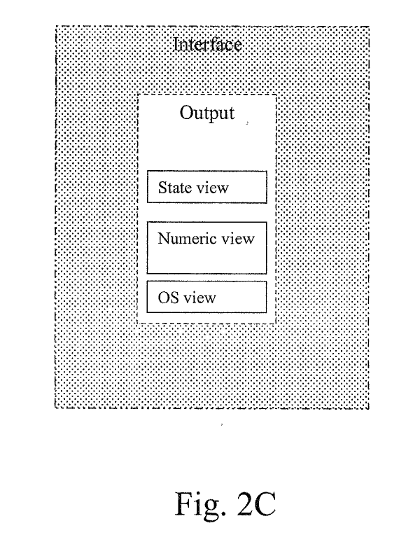

FIGS. 2A, 2B and 2C illustrate the quantum logic design process, in a relationship diagram format. FIG. 2A illustrates the operation sequence designing tools including the step of compiling, specifying the driver details, specifying the initial conditions of the quantum computing system, and compiling a quantum machine language instruction set. In some embodiments of the invention, the initial conditions of the qubits in the quantum computing system are set to the |0> state by default.

The set of quantum machine language instructions dictates which operations are to be performed in the quantum register in a time-resolved manner. Once compiled, the quantum machine language instructions can be executed by a control system and driver, which makes use of the control aspects provided by a quantum register, as shown in FIG. 2B.

Finally, FIG. 2C illustrates how the results of the execution of the quantum machine language instructions can be provided as an output. For example, useful forms of output can be the final state of the register, in terms of classical values, such as 0 or 1, or for simulated embodiments, the evolution of the quantum state of the quantum register can be monitored on a plot that compares the normalized magnitdues superposition of states.

In some embodiments of the invention, the quantum computing system of the QC-IDE can only be initialized to a classical state of either |0> or |1>, and thereafter can evolve to a superposition of states. In this case, a set of abstract operators can be used to provide quantum logic for evolving the quantum computing system to a superposition of states useful for the calculation.

In some embodiments of the invention, a conventional computer, including a processor, memory, and a graphical interface (GI), can be used for designing, compiling, and providing output from the execution, and a quantum computer can be used for executing the machine language instructions (FIG. 2B). In some embodiments of the invention the quantum computing system is simulated by a computer program executed by a classical (e.g. digital) computer. In such embodiments, a superposition of states of the quantum computing system can be prepared based on input from the initial conditions. Since the initialization operation available in a quantum computer can only initialize a qubit to either the |0> or |1> state, initialization to a superposition of states is physically unrealistic. For simulation purposes, however, it may be sometimes useful to bypass the initialization process and initialize the quantum computing system directly.

Some embodiments of the invention can use a classical computer, including a processor, memory, and a GI, for designing, compiling, executing, and providing output for the quantum computing integrated development environment. Thus in some embodiments of the invention a quantum computing system can be simulated using a classical computer.

Embodiments of the invention in which the quantum computing system is simulated include the time-dependent Schrödinger equation (TDSE) in the Hilbert space generated by N two level systems (qubits). The Hamiltonian of a generic system can be represented by the following:

$$\hat{H} ( t ) = {\sum }_{j = 1}^{N} [ {Δ}_{j}^{( x )} ( t ) {\hat{σ}}_{x}^{j} + {Δ}_{j}^{( y )} ( t ) {\hat{σ}}_{y}^{j} + {ϵ}_{j} ( t ) {\hat{σ}}_{z}^{j} ] + {\sum }_{k < m}^{N} {J}_{km} ( t ) {\hat{σ}}_{z}^{k} {\hat{σ}}_{z}^{m} ,$$

where the first three terms are the usual Pauli matrices X, Y, and Z, combined with the driver details, A and Σ respectively, and the last term is a controlled-phase type coupling. The effect of an entanglement operation depends on the particular embodiment of the invention. The states in the Hilbert space are labeled in the regular binary form, with “qubit 1” always the rightmost digit and “qubit N” always the leftmost.

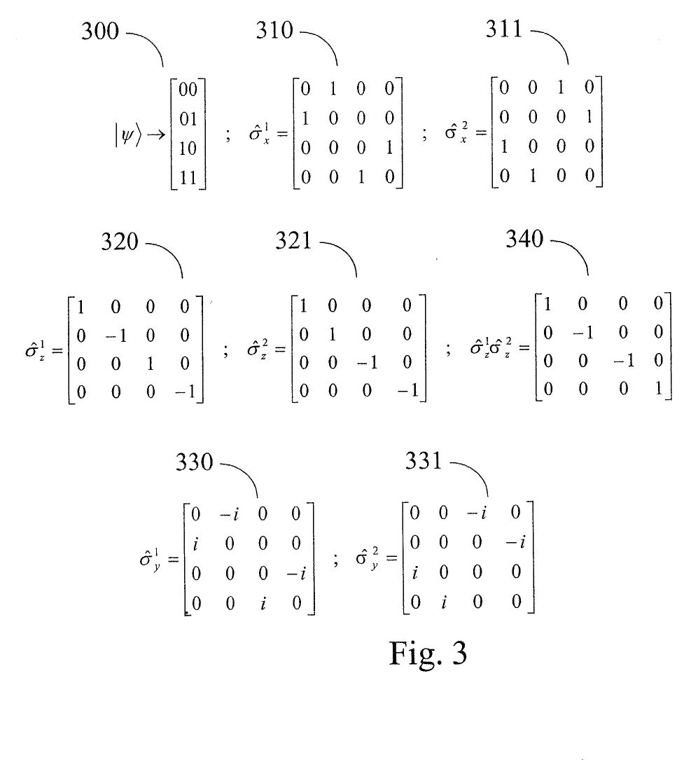

FIG. 3 illustrates the set of matrices available for a 2-qubit quantum computing system, including the possible states of the quantum register. Matrix 300 illustrates the possible states of the 2-qubit system as correlated with standard binary notation. The quantum register can simultaneously exist in a superposition of each of the states, having some complex probability γ₀, γ₁, γ₂, and γ₃ of being in each of the states, respectively. Matrices 310 and 311 represent the matrices of the X operator acting on the first and second qubits in a quantum register respectively. Matrices 320 and 321 represent the matrices of the Z operator acting on the first and second qubits in a quantum register, respectively. Matrices 330 and 331 represent the matrices of the Y operator acting on the first and second qubits in a quantum register, respectively. Matrix 340 represents the matrix of the coupling operator acting to couple the first and second qubits in the quantum register, wherein the coupling operation represents a controlled phase operation. In an N qubit quantum register, these matrices can be scaled to become 2^{N}×2^{N} matrices acting on the corresponding qubit or qubits.

In some embodiments of the invention, executing the machine language instruction set includes simulating a quantum computing system. The quantum register evolves according to the application of the available set of fundamental operators. As described above, the simulated evolution of a quantum register can be described by solving the time-dependent Schrödinger equation. The Hamiltonian of the system contains all of the time-resolved behavior of the system, including the sequencing of fundamental operators as well as potential sources of error or dissipation, and is represented by a 2^{N}×2^{N} matrix, where N represents the number of qubits in the system. Each of the fundamental operators can be described by a 2^{N}×2^{N} unitary matrix, each of which correlates with a specific evolution of the state of the quantum register. In some embodiments of the invention, a simulation of a quantum system includes preparing a 2^{N}×2^{N} time-dependent matrix representing the Hamiltonian of the system to be solved, where N represents the number of qubits in the system, and numerically solving the Schrödinger equation using said prepared time-dependent Hamiltonian. A data structure useful for storing the Hamiltonian information can be a “Sparse Matrix” data type, defined in an exemplary manner in the attached code, wherein all elements in the Hamiltonian can be stored in a hash table, keyed by matrix entry value by row and column, and each element in the matrix can store the time-dependent complex numbers that represent a fundamental operator being applied. Some of the fundamental operators have matrices with entries only along the diagonal. A data structure useful for these fundamental operators can be a “diagonal matrix” data type, defined in an exemplary manner in the attached code, wherein the data type need only maintain information regarding 2^{N} states, which is the number of elements along the diagonal. Since the elements are known to be placed linearly along the diagonal of the matrix, a sparse matrix data structure would reduce efficiency. Thus, the Hamiltonian can be generated by summing each of the matrices for each of the fundamental operators being applied to the system. In some embodiments of the invention, potential sources of decoherence can be taken into account and further incorporated in the Hamiltonian.

The quantum machine language used in the compilation process can vary depending on the target quantum computing system. Different quantum computing systems can have different sets of fundamental operators. A quantum computing system has operators sufficient to form a universal set. Some embodiments of the invention can compile quantum logic in terms of quantum machine language that is specific to any predetermined quantum computing system.

Some embodiments of the invention can be used to test the operation of aspects of a quantum computing system. For example, the QC-IDE provides a convenient, intuitive environment for implementing simple operations that can be used to characterize important aspects of a quantum computing system. A method for calibrating a quantum computing system can include initializing a quantum register, evolving the register to some superposition of states, evolving the state of the quantum register, and reading out the result of the evolution. For example, some embodiments of the invention can be used to calibrate a single qubit in a quantum register, in which a qubit can be initialized and subsequently read out, to gather information regarding inherent decoherence processes in the quantum computing system. Furthermore, after initialization, a sequence of fundamental operators can be applied to the qubit, before the readout operation is applied. Through a process of repeated measurement, a statistical analysis of that particular qubit in the quantum computing system can be gathered as related to each of the fundamental operations applicable to a single qubit for the given quantum computing system. The procedure can extend to a calibration of a plurality of qubits, where N qubits in a quantum computing system can be calibrated, and furthermore the interaction operators can be tested as well.

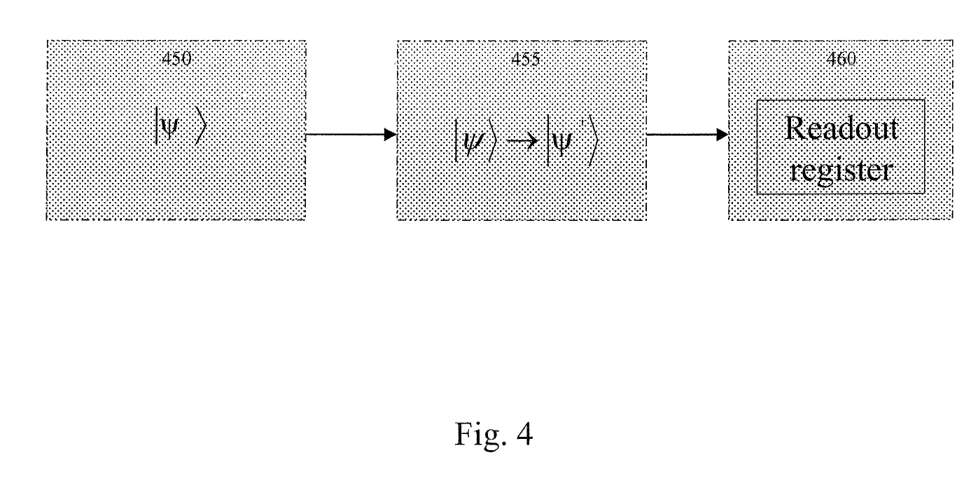

FIG. 4 illustrates an application of the QC-IDE as a calibration tool for a quantum computing environment. State 450 represents the initial state of the quantum register for the calibration. This state depends on the number of qubits involved in the calibration. Stae 450 represents the initial state of the register as prepared by the control system. Typically the register can begin in some single classical state rather than in some superposition of states. Evolution of the initial state 450 of the quantum computing system can then be accomplished in operation 455, where some sequence of fundamental operators can be used to evolve the state of the quantum computing system. Once said sequence of fundamental operators has been applied, a readout operation 460 can be performed on the quantum computing system. The output from the register can thus be correlated with the input state and sequence of applied fundamental operators to determine information about the quantum system.

Embodiments described above illustrate but do not limit the invention. In particular, the invention is not limited to any particular quantum computing system. In addition, the invention is not limited to any particular software or hardware package used to design and/or compile quantum logic. In fact, other software and hardware packages could be used in place of the ones described herein, in accordance to the principles of the invention. Other embodiments and varieties are within the scope of the invention, as defined by the following claims.

[image]

[image]

[image]

We claim:

1. A quantum computing integrated development environment (QC-IDE) comprising:
a computer; and
a computer program executed by the computer, wherein the computer program includes computer instructions for:
designing quantum logic with N qubits; and
compiling the quantum logic into a set of quantum machine language instructions;
wherein the quantum machine language instructions are executable by a quantum computing system.

2. The QC-IDE of claim 1, wherein a set of quantum machine language instructions includes a set of hardware executable instructions, wherein at least one instruction in said instruction set can only be executed on quantum computing hardware.

3. The QC-IDE of claim 2, wherein said set of quantum machine language instructions further includes instructions executable on classical computing hardware.

4. The QC-IDE of claim 1, wherein the computer program includes computer instructions for preparing a sequence of fundamental operators.

5. The QC-IDE of claim 4, wherein the sequence of fundamental operators includes all possible unitary transformations for a particular quantum computing system.

6. The QC-IDE of claim 5, wherein a quantum computing system is any quantum system that provides a universal set of unitary operators.

7. The QC-IDE of claim 5, wherein a fundamental operator has a unitary, 2^{N} by 2^{N} matrix.

8. The QC-IDE of claim 7, wherein a single qubit fundamental operator is represented by a unitary matrix
$${\hat{σ}}_{x} = [ \begin{matrix}0 & 1 \\ 1 & 0\end{matrix} ] .$$

9. The QC-IDE of claim 7, wherein a single qubit fundamental operator is represented by a unitary matrix
$${\hat{σ}}_{z} = [ \begin{matrix}1 & 0 \\ 0 & - 1\end{matrix} ] .$$

10. The QC-IDE of claim 7, wherein a single qubit fundamental operator is represented by a unitary matrix
$${\hat{σ}}_{y} = [ \begin{matrix}0 & - i \\ i & 0\end{matrix} ] .$$

11. The QC-IDE of claim 4, wherein a sequence of fundamental operators applies to a single qubit.

12. The QC-IDE of claim 4, wherein a sequence of fundamental operators applies to a plurality of qubits.

13. The QC-IDE of claim 11 wherein the computer program includes computer instructions for defining a sequence of fundamental operators as a single abstract operator.

14. The QC-IDE of claim 1, wherein the computer program includes computer instructions for preparing a sequence of abstract operators.

15. The QC-IDE of claim 1, wherein the computer program includes computer instructions for setting the driver specifications.

16. The QC-IDE of claim 12, wherein the computer program includes computer instructions for setting the frequency of the fundamental operators.

17. The QC-IDE of claim 16, wherein the frequency of fundamental operators can be set for each fundamental operator.

18. The QC-IDE of claim 16, wherein setting the frequency of a fundamental operator includes setting:
the sharpness of the pulses;
the time unit of the pulses; and
the amplitude of the pulses.

19. The QC-IDE of claim 1, wherein the computer program includes computer instructions for selecting a quantum computing system.

20. The QC-IDE of claim 1, wherein designing quantum logic includes defining a quantum computing system.

21. The QC-IDE of claim 20, wherein defining a quantum computing system includes specifying a set of fundamental operations.

22. The QC-IDE of claim 20, wherein defining a quantum computing system includes specifying a noise level in the system.

23. The QC-IDE of claim 20, wherein defining a quantum computing system further includes defining driver specifications.

24. The QC-IDE of claim 1, wherein the computer program includes computer instructions for
preparing a sequence of fundamental operators,
preparing an abstract operator, and
preparing a sequence of abstract operators.

25. The QC-IDE of claim 1, wherein the computer program includes computer instructions for converting said quantum logic between a sequence of abstract operators and a sequence of fundamental operators.

26. The QC-IDE of claim 1, wherein converting between a sequence of abstract operators and a sequence of fundamental operators includes use of a set of simplification rules.

27. The QC-IDE of claim 26, wherein a simplification rule is commutation of fundamental operators.

28. The QC-IDE of claim 26, wherein a simplification rule is redundancy between fundamental operators.

29. The QC-IDE of claim 25, wherein the computer instructions for converting quantum logic between a sequence of abstract operators and a sequence of fundamental operators includes computer instructions for representing each abstract operator in said sequence as an equivalent sequence of fundamental operators.

30. A method for quantum computing, the method comprising:
designing quantum logic with N qubits;
compiling the quantum logic into a set of quantum machine language instructions;
executing the quantum machine language instructions on a quantum computing system; and
outputting results of the execution of the quantum machine language instructions.
